(19) United States
(12) Patent Application Publication
(10) Pub. No.: US 2008/0270619 A1
(43) Pub. Date: Oct. 30, 2008

(54) Method and Apparatus for Use in Off-Line P2p Communication

(75) Inventors: Robert James Davies, Shanghai (CN); Li Sun, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,285

(22) PCT Filed: Aug. 3, 2005
(86) PCT No.: PCT/IB2005/052591

§ 371 Date: Jun. 10, 2008

(30) Foreign Application Priority Data
Aug. 10, 2004 (CN) 200410056539.5

(51) Int. Cl. H04Q 7/38; H04L 29/06; H04L 12/14

(52) U.S. Cl. 709/229

(57) ABSTRACT

A method for use in off-line P2P communication to be executed in a communication network system is proposed, comprising: receiving a request for registering off-line P2P communication service from a UE; judging whether the UE satisfies the predefined requirements for performing off-line P2P communication according to the request; generating an authentication information according to the judgment result, the authentication information indicating whether the UE can use off-line P2P communication service; sending the authentication information to the UE.

### FIELD OF THE INVENTION

The present invention relates generally to a wireless communication network, and more particularly, to a method and apparatus for P2P communication in the wireless communication network.

### BACKGROUND ART OF THE INVENTION

In conventional cellular mobile communication systems, a UE (user equipment) has to communicate with another UE through the relaying of base stations. FIG. 1 illustrates this conventional communication mode used in TD-SCDMA system, in which UE1 and UE2 exchange information through UTRAN consisting of a base station transceiver (Node B) and a RNC (radio network controller). This conventional communication mode is also called as UP-UTRAN-DOWN mode. But in some cases where two users camping in a cell are very close to each other, it can be a more reasonable way for them to communicate directly rather than through the relaying/forwarding of base stations, and this is the so-called peer-to-peer communication, abbreviated as P2P.

FIG. 2 shows a P2P communication mode in TD-SCMDA system. As shown in FIG. 2, there only exists control link (represent by the dashed line) for transferring signaling between UTRAN and UE1 and UE2, whereas there only exists P2P direct link (represented by the solid line) for transferring traffic data between the communicating UE1 and UE2. Compared with conventional communication mode, P2P communication can save up to 50% radio resource, and at the same time UTRAN still keeps control of the P2P communication, especially the usage of radio resource, thus it's very easy for network operators to charge for the radio resource used by P2P communication.

This P2P communication mode under the control of UTRAN is also called as online P2P communication mode, as described in the patent applications filed by KONINKLIJKE PHILIPS ELECTRONICS N.V. on Mar. 7, 2003, with the Application Serial No. as 03119892.9 and 03119894.5, and incorporated herein as reference.

Based on the above online P2P communication mode, a new communication mode can be proposed for the UEs to enable P2P communication in a self-organizing way without control of the base station, and this is off-line P2P communication mode. In off-line P2P communication mode, not only signaling overhead can be saved, but also communication can be established even two UEs to launch communication fall outside the coverage of the wireless communication network, such as ocean, mountain or battlefield and so on.

FIG. 3 shows off-line P2P communication mode in TD-SCDMA system. As shown in the FIG. 3, first of all, UE1 and UE2 to perform off-line P2P communication acquire the P2P communication identification codes of itself and their peer in conventional communication mode. As to the method for acquiring P2P communication identification codes, descriptions are given in detail in the patent application filed by KONINKLIJKE PHILIPS ELECTRONICS N.V. along with the present application, with Attorney's Docket No. as CN040033, and incorporated herein as reference.

Then, UE1 and UE2 establish and maintain P2P communication with the acquired P2P communication identification codes, without control of UTRAN. The above procedure is described in detail in the patent application filed by KONINKLIJKE PHILIPS ELECTRONICS N.V. along with the present application, with attorney's Docket No. as CN040035, and incorporated herein as reference.

During off-line P2P communication procedure, there is no control link between UTRAN and UE1 and UE2, so UE1 and UE2 have to record their communication duration and service type by themselves and report the records to UTRAN respectively as reference for the billing job of the network operator when returning to conventional communication mode after P2P communication is completed. As to how to implement the billing method in off-line P2P communication mode, descriptions are given in detail in the patent application filed by KONINKLIJKE PHILIPS ELECTRONICS N.V. along with the present application, with attorney's Docket No. as CN040036, and incorporated herein as reference.

However, the practicability of the billing system may be affected with this method in which the UE records communication duration and service type and then UTRAN carries out the billing according to the information reported by the UE. It is, therefore, necessary to propose an easier and more operable off-line P2P communication method.

### SUMMARY OF THE INVENTION

An object of the present invention is to provide a method and apparatus for off-line P2P communication, with which off-line P2P communication can be established between two UEs without increasing complexity of the billing system of current communication networks.

Another object of the present invention is to provide a method and apparatus for off-line P2P communication, with which the UEs can select parameters for off-line P2P communication according to whether they are inside or outside the coverage of the communication network, so as to mitigate the interference caused by adopting off-line P2P communication mode to conventional communication.

Yet another object of the present invention is to provide a method and apparatus for off-line P2P communication, with which the UEs can use the radio resource of the communication network independently, thus to further increase the capacity of the communication network.

A method for offline P2P communication to be executed in a communication network system is proposed according to the present invention, comprising: receiving a request for registering off-line P2P communication service from a UE; judging whether the UE satisfies the predefined requirements for performing off-line P2P communication according to the request; generating an authentication information according to the judgment result, the authentication information indicating whether the UE can uses offline P2P communication service; sending the authentication information to the UE.

A method for off-line P2P communication to be executed in a UE is proposed according to the present invention, comprising: sending a request for registering off-line P2P communication to a communication network system; receiving an authentication information from the communication network system, the authentication information indicating whether the UE can use off-line P2P communication service; judging whether offline P2P communication can be initiated according the authentication information.

A communication network system is proposed according to the present invention, comprising: a receiving unit, for receiving a request for registering off-line P2P communication service from a UE; a judging unit, for judging whether the UE satisfies the predefined requirements for performing off-line P2P communication according to the request; a generating unit, for generating an authentication information according to the judgment result, the authentication information indicating whether the UE can use offline P2P communication service; a sending unit, for sending the authentication information to the UE.

A UE is proposed according to the present invention, comprising: a sending unit, for sending a request for registering off-line P2P communication to a communication network system; a receiving unit, for receiving an authentication information from the communication network system, the authentication information indicating whether the UE can use offline P2P communication service.

Other objects and attainments together with a more fully understanding of the invention will become apparent and appreciated by referring to the following description and claims taken in conjunction with the accompanying drawings.

### BRIEF DESCRIPTION OF THE DRAWINGS

Full descriptions will be given below to the present invention in conjunction with specific embodiments and accompanying drawings, in which:

FIG. 1 is a diagram showing a TD-SCDM system adopting conventional communication mode;

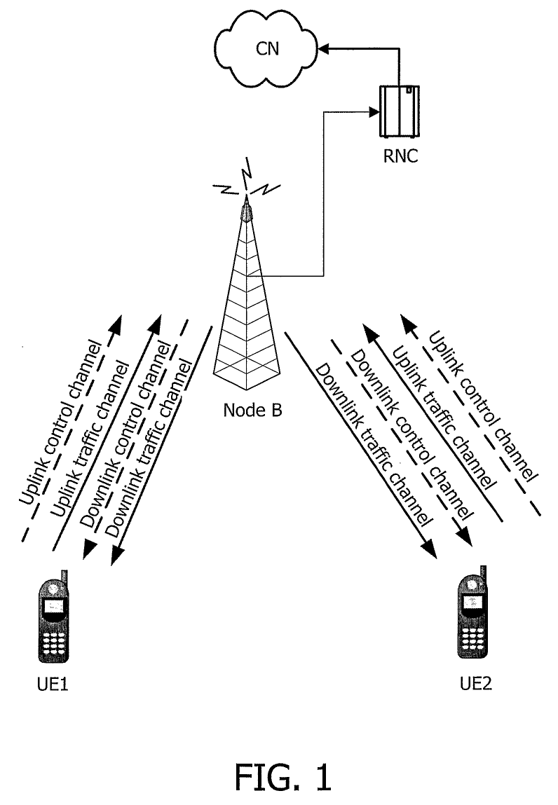

FIG. 2 is a diagram showing a TD-SCDMA system adopting online P2P communication mode;

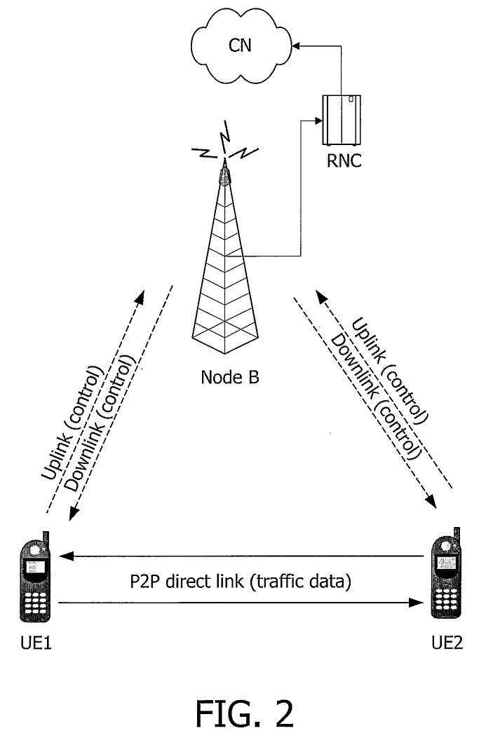

FIG. 3 is a diagram showing a TD-SCDMA system adopting off-line P2P communication mode;

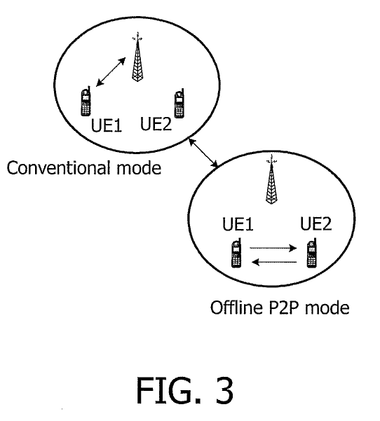

FIG. 4 is a flowchart illustrating the method for P2P communication in accordance with an embodiment of the present invention;

FIG. 5 is a block diagram showing the architecture of the UE and communication network system for implementing the off-line P2P communication method in accordance with the present invention.

In all of the drawing figures, the same reference numerals will be understood to refer to like or corresponding feature or function.

### DETAILED DESCRIPTION OF THE INVENTION

According to the P2P communication method proposed in the present invention, a user who is to use off-line P2P communication mode purchases the license for off-line P2P communication from the wireless communication network operator through paying a predefined fee. After obtaining the authorization identifier indicating the user can use off-line P2P communication service as provided by the operator, the user can start off-line P2P communication with other users with this authorization identifier.

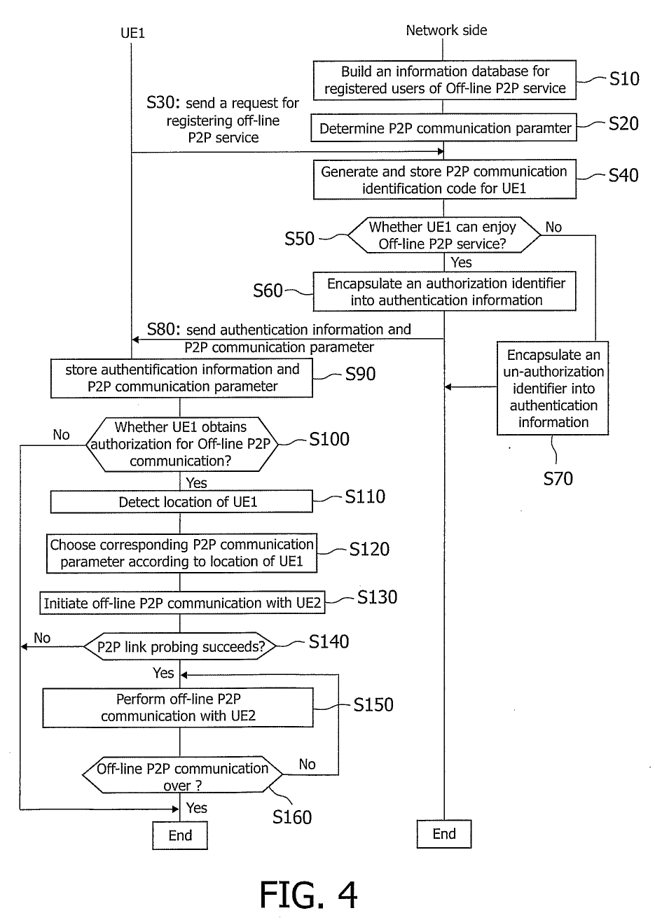

A TD-SCDMA system will be taken as an example in the following, to describe the off-line P2P communication method as proposed in the present invention, in conjunction with FIG. 4.

I Registering Off-Line P2P Communication Service

First of all, an information database for registered users of off-line P2P communication service is built at the network of the wireless communication network, to store the user ID (such as IMSI: International Mobile Subscriber Identity) for each registered user of off-line P2P communication service and its P2P communication identification code (step S10).

Then, different P2P communication parameters are set according to whether the location of the user is inside or outside the coverage of the wireless communication network, so that users can control the transmission power of their UEs during off-line P2P communication according to the P2P communication parameters, such as the transmission power for P2P communication (step S20).

As to the P2P communication parameters, at least two groups of values can be set according to whether the location of the UE is inside or outside the coverage of the wireless communication network. If the UE is inside the coverage of the wireless communication network, since interference may be produced between off-line P2P communication and conventional communication, setting offline P2P communication parameters should be strictly controlled by considering the operation status of the wireless communication network and the radio resource allocation scheme adopted, so as to limit the radio transmission range of off-line P2P communication, thus to avoid interference between off-line P2P communication and conventional communication as much as possible. Conversely, if the UE is outside the wireless communication network coverage, since no interference will be produced between off-line P2P communication and conventional communication, setting P2P communication parameters can be relatively loose, so as to extend the radio transmission range of off-line P2P communication.

Furthermore, as to the UE outside the coverage of the wireless communication network, its P2P communication parameters can be set as different groups of values. Taking the maximum transmission power as an example, the maximum transmission power with different values can be set to adapt the requirement for off-line P2P communication under different situations, such as different visibility.

When a network, where P2P communication parameters are set and information about registered users for offline P2P communication service can be stored, receives an off-line P2P communication service registration request from UE1 (step S30), the network responds the request, to generate a P2P communication identification code to identify UE1 in off-line P2P communication and store the P2P communication identification code to identify UE1 in the information database along with the user ID of UE1 correspondingly (step S40).

Next, the network judges whether UE1 satisfies the predefined requirements for using offline P2P communication service, for instance, whether UE1 has paid the predefined fee for off-line P2P communication (step S50). If UE1 satisfies the predefined requirements, the network generates an authorization identifier for UE1 to indicate that UE1 can use off-line P2P communication service, the authorization identifier being encapsulated in an authentication information to be sent to UE1 (step S60), the authentication information indicating whether UE1 can use off-line P2P communication service. If UE1 does not satisfy the predefined requirements, the network generates an un-authorization identifier, which indicating that UE1 can't use off-line P2P communication service, the un-authorization flag also being encapsulated in the authentication information (step S70).

Afterwards, the network sends the authentication information to UE1 along with the P2P communication parameters (step S80). Further, the network can also send the authentication information and P2P communication parameters to UE1 respectively.

Upon receipt of the authentication information and P2P communication parameters, UE1 stores them so as to be called when performing off-line P2P communication (step S90), wherein the authentication information is stored in the SIM card for example, for the UE to judge whether UE1 can start off-line P2P communication and the P2P communication parameters are stored in the SIM card or in the memory of the UE, for UE1 to control the transmission power of the UE during off-line P2P communication.

II Start Off-Line P2P Communication

When UE1 attempts to establish off-line P2P communication with another UE such as UE2, an authenticating module in UE1 first judges whether the UE has obtained the authorization to start off-line P2P communication according to the authentication information stored in the SIM card of UE1 (step S100).

The operations to be executed by the authenticating module are as follows: reading the authentication information stored in the SIM card and then determining whether to start off-line P2P communication according to the authentication information. If the authentication information includes an authorization identifier, that is, UE1 can use off-line P2P communication service; UE1 starts off-line P2P communication with UE2. If the authentication information includes a un-authorization identifier, that is, UE1 can't use off-line P2P communication service, UE1 stops the attempt to establish off-line P2P communication with UE2, and feeds back a notification saying, “You can't use off-line P2P communication service”.

The authenticating module can be implemented in software or hardware, or in combination of both. While the authenticating module is implemented in software, the application of the software can be pre-solidified in UE1, or downloaded to UE1 from the network. If UE1 obtains the authenticating module from the network, UE1 can install the downloaded authenticating module by running the application, so that UE1 can have the capability to determine whether to start off-line P2P communication according to the above authentication information.

If off-line P2P communication can be enabled according to the authentication information, UE1 selects the corresponding P2P communication parameters according to its location, so as to control its transmission power when establishing and maintaining off-line P2P communication. A P2P communication parameter-calling module in UE1 executes these operations, and the steps are as follows:

Detect the strength of pilot signals from the wireless communication network, to determine whether UE1 is inside or outside the coverage of the wireless communication network (step S110). In TD-SCDMA system, the location of UE1 can be determined through detecting the signal strength in DwPTS (Downlink Pilot Time Slot) or CCPCH (Primary Common Control Physical Channel).

According to the detected location information, the P2P communication parameter-calling module selects a corresponding group of P2P communication parameters from the P2P communication parameters stored in the SIM card or memory of UE1 (step S120). That is, if UE1 is outside the radio communication range, UE1 selects the P2P communication parameters corresponding to the case where the UE is outside the radio communication range, to extend the radio transmission range of P2P communication; if UE1 is inside the radio communication range, UE1 selects the P2P communication parameters corresponding to the case that the UE is inside the radio communication range, to limit the radio communication range of P2P communication, or UE1 reads the P2P communication parameters relevant to off-line P2P communication sent by the network over BCCH (Broadcast Control Channel), to limit the value of the maximum transmission power more strictly.

The P2P communication parameter-calling module can be implemented in software or hardware, or in combination of both. While it's implemented in software, the application of the software can be pre-solidified in UE1, or downloaded to UE1 from the network. If UE1 obtains the P2P communication parameter-calling module from the network, UE1 can install the downloaded P2P communication parameter-calling module by running the application, so that UE1 can have the capability to select corresponding P2P communication parameters according to its location inside or outside the coverage of the communication network.

After obtaining the corresponding P2P communication parameters, UE1 can initiate off-line P2P communication with UE2 (step S130). Wherein, when establishing P2P link with UE2, UE1 can input the P2P communication identification code of UE2 directly via the human-machine interface, or input the user ID of UE2 first and then find the corresponding P2P communication identification code of UE2 from the mapping relationship between P2P communication identification codes and user IDs of UE2 stored in the network or UE1. As to how UE1 acquires the P2P communication identification codes of UE2, descriptions are given in detail in the patent application filed by KONINKLIJKE PHILIPS ELECTRONICS N.V. along with the present application, with attorney's Docket No. as CN040033, and incorporated herein as reference.

III Perform Link Probing for Offline P2P Communication

With the corresponding P2P communication parameters determined, UE1 attempts a link probing, to establish P2P communication link with UE2 (step S140).

First, UE1 takes the maximum transmission power for link probing in the P2P communication parameters as the initial probing power, to probe the P2P communication link. During probing, UE1 can adjust the transmission power according to the communication requirement, but it must control its transmission power according to the value of the maximum transmission power for link probing in the called P2P communication parameters, to make it not exceed the maximum transmission power.

If the probing fails, UE1 terminates the operation to attempt off-line P2P communication establishment with UE2. If the probing succeeds, UE1 starts off-line P2P communication, taking the probing power as its transmission power (step S150).

IV Maintain Offline P2P Communication

After P2P link probing succeeds, UE1 and UE2 enter into off-line P2P communication mode. In off-line P2P communication, UE1 and UE2 keep on adjusting their transmission power with the change of communication environment. UE1 controls its transmission power according to the value of the maximum transmission power for offline P2P communication in the called P2P communication parameters, to make it not above the maximum transmission power.

As to the above procedure of performing link probing with P2P communication parameters and controlling off-line P2P communication transmission power according to P2P communication parameters, descriptions are disclosed in detail in the patent application filed by KONINKLIJKE PHILIPS ELECTRONICS N.V., with attorney's Docket No. as CN040035, along with the present application and incorporated herein as reference.

V Terminate Offline P2P Communication

When UE1 and UE2 terminate the off-line P2P communication (step S160), if the P2P communication identification code of UE2 is not yet stored in UE1, UE1 can save the P2P communication identification code of UE2 according to the requirement of UE1's user, so as to use when establishing offline P2P communication with UE2.

The above description goes to the procedure where a registered user of off-line P2P service to purchase off-line P2P communication license from the wireless communication network operator in a prepaying way, establishes and maintains off-line P2P communication with another registered user of off-line P2P service. The time duration for off-line P2P communication obtained by the UE is to be decided by the prepaid fee of the user.

In practical applications, there can be other ways to obtain off-line P2P communication service from the network operator, in addition to the prepaying way to obtain off-line P2P communication license.

For example, in the network, the communication holding duration or data traffic of the UE in conventional communication mode can be accumulated, and the time duration for off-line P2P communication obtained by the user is thus decided by the accumulated time. Then, the network can encapsulate the off-line P2P communication time duration, which the user can use, into the authentication information and send it to the UE.

When attempting to perform offline P2P communication with other users, a billing module in the UE first detects whether off-line P2P communication time duration to be used by the UE is included in the authentication information stored in the UE. If there is off-line P2P communication time duration to be used by the UE, the billing module starts a timer in UE1, for accumulating the UE's time of off-line P2P communication.

The billing module not only can show the offline P2P communication time remained to the user via the human-machine interface, but also can prompt the user to purchase offline P2P service when the off-line P2P communication time remained is below a predefined value.

When the P2P communication time accumulated by the timer exceeds the off-line P2P communication time duration to be used by the user, the billing module sets the authentication information as un-authorization identifier so that the user of the UE terminates off-line P2P communication with other users.

Only when the communication duration of the user for conventional communication mode reaches a predefined value again and thus the network generates new authentication information including the authorization identifier, can the user start off-line P2P communication with another user using the received authorization information.

The above billing module can be implemented in software or hardware, or in combination of both. When the billing module is implemented in software, the application of the software can be pre-solidified in the UE, or downloaded to the UE from the network. If the UE obtains the billing module from the network, the UE can install the downloaded billing module by running the application, so that the UE can possess the capability to determine whether to continue off-line P2P communication according to the accumulated P2P communication time.

The method for offline P2P communication as proposed in the present invention can be implemented in software or hardware, or in combination of both.

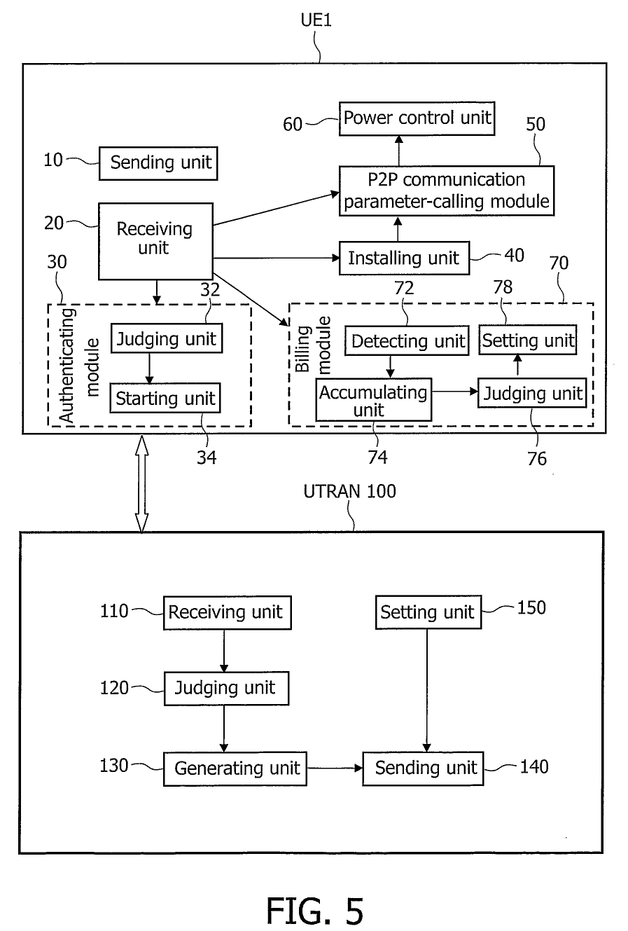

FIG. 5 is a block diagram illustrating architecture of the UE1 and network system UTRAN in a procedure to realize off-line P2P communication in accordance with an embodiment of the present invention, wherein components same as those in conventional network system and UE are not given.

As shown in FIG. 5, UTRAN 100 comprises: a receiving unit 110, for receiving a request for registering off-line P2P communication service from UE1; a judging unit, for judging whether UE1 satisfies the predefined requirements for off-line P2P communication according to the request; a generating unit 130, for generating an authentication information according to the judgment result, the authentication information indicating whether UE1 can use off-line P2P communication service; a sending unit 140, for sending the authentication information to UE1.

Wherein the authentication information includes an authorization identifier, which indicating the UE can use off-line P2P communication service if UE1 satisfies the predefined requirement. The authentication information can further include the predefined time duration for UE1 to perform off-line P2P communication. The predefined time duration is decided by UE1's prepaid fee for off-line P2P communication, or the accumulated time of UE1 in conventional communication mode.

UTRAN further comprises a setting unit 150, for setting the P2P communication parameters that are to be sent to UE1 via sending unit 140, so that UE1 can control its transmission power in off-line P2P communication according to the P2P communication parameters.

UE1 comprises: a sending unit 10, for sending a request for registering off-line P2P communication to UTRAN; a receiving unit 20, for receiving an authentication information from UTRAN, the authentication information indicating whether the UE can use off-line P2P communication service; an authenticating module 30, for judging whether off-line P2P communication can be enabled according to the authentication information, wherein judging unit 32 is used to judge whether said authentication information contains an authorization identifier, the authorization flag indicating the UE can use off-line P2P service, starting module 34 is used to start off-line P2P communication with said another UE when said authentication information contains the authorization identifier and not to start off-line P2P communication with said another UE when said authentication information contains the un-authorization flag. If the UE1 hasn't registered off-line P2P communication service yet, there is the default authentication information including a un-authorization identifier in UE1.

UE1 further comprises a P2P communication parameter calling module 50, for detecting the location of UE1 and choosing a corresponding group of P2P communication parameters from the P2P communication parameters from UTRAN received by receiving unit 20 according to the detection result; and a power control unit 60, for controlling the transmission power for off-line P2P communication using the selected P2P communication parameters.

UE1 further comprises a billing module 70, which further includes: a detecting unit 72, for detecting whether the authentication information contains the predefined time duration for UE1 to perform off-line P2P communication; an accumulating unit 74, for accumulating the time for the UE to perform P2P communication; a judging unit 76, for judging whether the accumulated time exceeds the predefined time duration; a setting unit 78, for setting the authentication information as an un-authorization identifier when the judging unit judges the predefined time duration is exceeded.

To realize the proposed off-line P2P communication method in conventional UEs, if UE1 doesn't has authenticating module 30, UE1 can download the authenticating module 30 from UTRAN via receiving unit 20 and run the authenticating module through an installing unit 40 so that UE1 can possess the capability to determine whether to start off-line P2P communication according to the authentication information.

If UE1 doesn't possess P2P communication parameter calling module 50, UE1 can download the P2P communication parameter-calling module 50 from UTRAN via receiving unit 20 and run the P2P communication parameter-calling module 50 through installing unit 40 so that UE1 can possess the capability to select corresponding off-line P2P communication parameters according to its location.

If UE1 doesn't possess billing module 70, UE1 can download the billing module 70 from UTRAN via receiving unit 20 and run billing module 70 through installing unit 40 so that UE1 can possess the capability to determine whether to perform off-line P2P communication according to the accumulated P2P communication time.

### BENEFICIAL USE OF THE INVENTION

With regard to the detailed description to the embodiment of the present invention taken in conjunction with accompanying drawings, it can be seen that in the method and apparatus for off-line P2P communication as proposed in the present invention, the UE can obtain license for off-line P2P communication from the network operator in the way of prepaying or accumulating communication time in conventional mode, thus the billing method in off-line P2P communication mode is simplified and the billing cost can be saved for the wireless communication network. Especially, in the way of obtaining off-line P2P communication authorization through accumulating communication time in conventional communication mode, the network operator can attract more users to use the conventional communication service, and thus increase the operation revenue in conventional communication mode.

Further, in the method and apparatus for offline P2P communication as proposed in the present invention, the UE can select corresponding P2P parameters according to whether it's inside or outside the coverage of the wireless communication network, thereby not only the radio interference caused by off-line P2P communication to conventional communication can be mitigated effectively and thus the capacity of the wireless communication network can be further improved when the UE is in the communication network coverage, but also the radio transmission range can be extended greatly when the UE is outside the communication network coverage, and thus P2P communication can provide a bright future outside the coverage of the wireless communication network.

Moreover, the method and apparatus for off-line P2P communication as proposed in the present invention, is used in practical applications in combination with conventional communication mode, that is, the UE scouts for P2P link probing signals while monitoring whether there are paging signals from conventional communication mode when the UE is in idle mode; the UE still keeps on monitoring its paging channel to prevent from missing paging from conventional communication mode when the UE is during P2P communication. Therefore, with the method and apparatus for off-line P2P communication as proposed in the present invention, stable conventional communication service can be achieved, and the broader communication space brought by P2P communication can be used as well.

It is to be understood by those skilled in the art that the method and apparatus for off-line P2P communication as disclosed in this invention can be made of various modifications without departing from the spirit and scope of the invention as defined by the appended claims.

1. A method for use in off-line P2P communication to be executed in a communication network system, comprising:
receiving a request for registering off-line P2P communication service from a UE;
judging whether the UE satisfies predefined requirements for performing off-line P2P communication according to the request;
generating authentication information according to the judgment result, the authentication information indicating whether the user can use off-line P2P communication service;
sending the authentication information to the UE.

2. The method for use in off-line P2P communication according to claim 1, wherein said authentication information at least includes an authorization identifier if the UE is satisfies the predefined requirements, the authorization identifier indicating said UE can use off-line P2P communication service.

3. The method for use in off-line P2P communication according to claim 2, wherein said authentication information further includes a predefined time duration for said UE to perform off-line P2P communication if the UE satisfies the predefined requirements.

4. The method for use in off-line P2P communication according to claim 3, wherein said predefined time duration is decided in one of the following two ways:
(1) determining the predefined time duration corresponding to a fee for off-line P2P communication prepaid by said UE;
(2) determining the predefined time duration corresponding to an accumulated time in which said UE communicates in conventional communication mode.

5. The method for use in off-line P2P communication according to claim 1, further comprising:
sending an authenticating module to said UE so that said UE has a capability to decide whether off-line P2P communication can be started according to said authentication information.

6. The method for use in off-line P2P communication according to claim 1, further comprising:
setting P2P communication parameters;
sending the P2P communication parameters to said UE so that said UE can control its transmission power according to the P2P communication parameters when performing off-line P2P communication.

7. The method for use in off-line P2P communication according to claim 6, wherein said P2P communication parameters at least include two groups of values and power control is implemented with one corresponding group of values in accordance with a location of said UE.

8. The method for use in off-line P2P communication according to claim 1, further comprising:
sending a P2P communication parameter-calling module to said UE so that said UE has a capability to select corresponding P2P communication parameters according to its location.

9. The method for use in off-line P2P communication according to claim 1, further comprising:
sending a billing module to said UE so that said UE has a capability to decide whether off-line P2P communication can be enabled according to the accumulated P2P communication time.

10. A method for use in off-line P2P communication to be executed in a UE, comprising:
sending a request for registering off-line P2P communication service to a communication network system;
receiving authentication information from the communication network system, the authentication information indicating whether the UE can use off-line P2P communication service;
judging whether off-line P2P communication can be started according to the authentication information.

11. The method for use in off-line P2P communication according to claim 10, wherein off-line P2P communication is initiated with another UE if said authentication information includes an authorization identifier, the authorization identifier indicating said UE can use off-line P2P communication service.

12. The method for use in off-line P2P communication according to claim 11, wherein offline P2P communication will not be initiated with another UE if said authentication information includes an un-authorization identifier, the un-authorization identifier indicating said UE can't use off-line P2P communication service.

13. The method for use in off-line P2P communication according to claim 10, further comprising:
receiving an authenticating module from said communication network system, the authenticating module being used to judge whether the UE can use off-line P2P communication service;
running the authenticating module so that said UE has a capability to decide whether off-line P2P communication can be started according to said authentication information.

14. The method for use in off-line P2P communication according to claim 10, further comprising:
receiving P2P communication parameters from said communication network system;
storing the P2P communication parameters so as to be used to control transmission power when performing offline P2P communication.

15. The method for use in off-line P2P communication according to claim 14, wherein said P2P communication parameters at least include two groups of values according to a location of said UE, the method further comprising:
detecting the location of said UE;
choosing a corresponding group of P2P communication parameters according to the detection result;
controlling the transmission power for off-line P2P communication by using the selected P2P communication parameters.

16. The method for use in off-line P2P communication according to claim 10, further comprising:
receiving a P2P communication parameter-calling module from said communication network system;
running the P2P communication parameter-calling module so that said UE has a capability to select P2P communication parameters corresponding to its location.

17. The method for use in off-line P2P communication according to claim 11, wherein said authentication information includes said authentication identification, the method further comprising:
detecting whether said authentication information further comprises a predefined time duration for said UE to perform off-line P2P communication;
accumulating the time for said UE in off-line P2P communication if said authentication information includes the predefined time duration;
judging whether the accumulated time exceeds the predefined time duration;
setting said authentication information as an un-authorization identifier if said predefined time duration is exceeded.

18. The method for use in off-line P2P communication according to claim 11, wherein said authentication information includes said authorization identifier, the method further comprising:
receiving a billing module from said communication network system;
running the billing module so that said UE has a capability to decide whether off-line P2P communication can be started according to the accumulated P2P communication time.

19. A communication network system, comprising:
a receiving unit, for receiving a request for registering off-line P2P communication service from a UE;
a judging unit, for judging whether the UE satisfies predefined requirements for performing off-line P2P communication according to the request;
a generating unit, for generating authentication information according to the judgment result, the authentication information indicating whether the UE can use off-line P2P communication service;
a sending unit, for sending the authentication information to the UE.

20. The communication network system according to claim 19, wherein said authentication information at least includes an authorization identifier if the UE satisfied the predefined requirements, the authorization identifier indicating said UE can use off-line P2P communication service.

21. The communication network system according to claim 19, wherein said authentication information further includes a predefined time duration for said UE to perform off-line P2P communication if the UE satisfies the predefined requirements.

22. The communication network system according to claim 21, wherein said predefined time duration is decided in one of the following two ways:
(1) determining a corresponding predefined time duration according to a fee for off-line P2P communication prepaid by said UE;
(2) determining a corresponding predefined time duration according to an accumulated time in which said UE communicates in conventional communication mode.

23. The communication network system according to claim 19, further comprising:
a setting unit, for setting P2P communication parameters;
wherein said sending unit sends P2P communication parameters to said UE so that said UE can control its transmission power according to the P2P communication parameters when performing off-line P2P communication.

24. A UE, comprising:
a sending unit, for sending a request for registering off-line P2P communication service to a communication network system;
a receiving unit, for receiving authentication information from the communication network system, the authentication information indicating whether the UE can use off-line P2P communication service;
an authenticating module, for judging whether off-line P2P communication can be started according to the authentication information.

25. The UE according to claim 24, wherein said authenticating module includes:
a judging module, for judging whether said authentication information includes an authorization identifier; the authorization identifier indicating said UE can use off-line P2P communication service;
a starting module, for starting off-line P2P communication with another UE when said authentication information includes an authorization identifier, and not starting off-line P2P communication with another UE when said authentication information includes an un-authorization identifier.

26. The UE according to claim 24, wherein said authenticating module is from said communication network system; the UE further comprising:
an installing unit, for running the authenticating module so that said UE has a capability to decide whether off-line P2P communication can be started according to said authentication information.

27. The UE according to claim 24, wherein said receiving unit receives P2P communication parameters from said communication network system, the UE further comprising:
a P2P communication parameter-calling module, for detecting a location of said UE and choosing a corresponding group of P2P communication parameters according to the detection result;
a power control unit, for controlling transmission power for off-line P2P communication using the selected P2P communication parameters.

28. The UE according to claim 26, wherein:
said receiving unit, for receiving a P2P communication parameter calling module from said communication network system; and
said installing unit, for running the P2P communication parameter calling module so that said UE has a capability to select P2P communication parameters corresponding to its location.

29. The UE according to claim 24, further comprising a billing module, the billing module comprising:
a detecting unit, for detecting whether said authentication information further comprises a predefined time duration for said UE to perform off-line P2P communication;
an accumulating unit, for accumulating the time for said UE to perform off-line P2P communication if said authentication information includes the predefined time duration;
a judging unit, for judging whether said accumulated time exceeds said predefined time duration;
a setting unit, for setting said authentication information as an un-authorization identifier if said predefined time duration is exceeded.

30. The UE according to claim 26, wherein:
said receiving unit, for receiving a billing module from said communication network system; and
said installing unit, for running the billing module so that said UE has a capability to decide whether offline P2P communication can be started according to the accumulated time for P2P communication.
